(19) United States
(12) Patent Application Publication
(10) Pub. No.: US 2010/0127811 A1
(43) Pub. Date: May 27, 2010

(54) Transformer with Center Tap Encompassing Primary Winding

(75) Inventors: Daniel Goluszek, El Dorado Hills, CA (US); Lawrence W. Goins, El Dorado Hills, CA (US)

Correspondence Address: ARTHUR J. BEHIEL;Silicon Edge Law Group LLP, 6601 KOLL CENTER PARKWAY, SUITE 245, PLEASANTON, CA, 94566, US

(73) Assignee: Polarity Inc., Rancho Cordova, CA (US)

(21) Appl. No.: 12/275,991

(22) Filed: Nov. 21, 2008

(51) Int. Cl. H01F 27/02; H01F 27/28

(52) U.S. Cl. 336/83; 336/220; 336/170

(57) ABSTRACT

A transformer housing encompasses a core and both primary and secondary windings. The primary or secondary windings can be incorporated into the housing, and the housing itself can provide a center tap for the transformer.

### FIELD

This invention relates to devices for efficiently down converting high DC supply voltages to relatively lower AC or DC voltages.

### BACKGROUND

Switch-mode DC-to-DC converters convert one DC voltage level to another. Such converters typically perform the conversion by applying AC voltage with a specific frequency and duty across the primary winding of a transformer, thereby coupling AC voltage to the secondary winding of the transformer. The AC voltage on the secondary winding can then be rectified to produce a DC output voltage. The turns ratio of the primary and secondary windings of the transformer determines, in part, the voltage step-up or step-down ratio provided by the converter. The output voltage can also be finely regulated using pulse-width-modulation (PWM) drive techniques.

Emerging applications for DC-to-DC converters require high efficiency conversion of relatively high input voltages. For example, a high-energy storage device described in U.S. Pat. No. 7,033,406 claims to safely store charge at 3,500 volts. This voltage will have to be down converted efficiently and regulated for use with equipment that requires relatively lower supply voltages. For example, conventional battery powered motor vehicles might benefit from a high-energy storage device, but the electric motors employed to drive them typically require input voltages of less than 100 volts. Voltage converters suitable for this task should be robust, inexpensive, and compact to ensure commercial viability. There is therefore a need for robust, compact, and efficient voltage converters that handle relatively high input voltages.

### BRIEF DESCRIPTION OF THE DRAWINGS

The subject matter disclosed is illustrated by way of example, and not by way of limitation, in the figures of the accompanying drawings and in which like reference numerals refer to similar elements and in which:

FIG. 1 depicts a voltage converter 100 in accordance with one embodiment.

FIG. 2 depicts a voltage converter 200 in accordance with another embodiment.

FIG. 3 depicts an output-regulated DC-to-DC converter system 300 in accordance with another embodiment.

FIG. 4A schematically depicts an output transformer 400, in accordance with one embodiment, coupled to a conventional rectifier 405.

FIG. 4B is a cross-sectional view of transformer 400, in accordance with one embodiment, mounted to an optional heat sink 410.

FIG. 5A includes plan, side, and cross-sectional views of a component 500 for use in transformer 400 of FIG. 4B.

FIG. 5B is an exploded view of a transformer body 535, which includes an opposing pair of components 500 of FIG. 5A, and a cylindrical core C.

FIG. 5C is an assembled view of transformer body 535 of FIG. 5B.

FIG. 5D shows an exploded view of assembly 535 similar to that of FIG. 5B but in cross-section.

FIG. 5E shows the elements of FIG. 5D assembled, in cross-section, and includes a plan view of the resulting assembly 535 to identify the cross-section of FIG. 5D as along line B-B.

FIG. 5F is the same view of transformer 400 provided in FIG. 4B but amended to include labels for the physical features of the same transformer illustrated schematically in FIG. 4A.

FIG. 6A depicts a housing portion 600, in accordance with another embodiment, that can be used with another similar juxtaposed housing portion (not shown) to form a transformer housing similar to that of FIG. 5A-5D.

FIG. 6B depicts a housing portion 615 in accordance with yet another embodiment.

FIG. 6C depicts a housing portion 630 in accordance with an embodiment in which a single-turn winding is formed of three conductors 635 attached to a housing portion 640.

FIG. 6D depicts a transformer 645 that employs two juxtaposed housing portions 630 of FIG. 6C to form a second of windings and a center tap.

### DETAILED DESCRIPTION

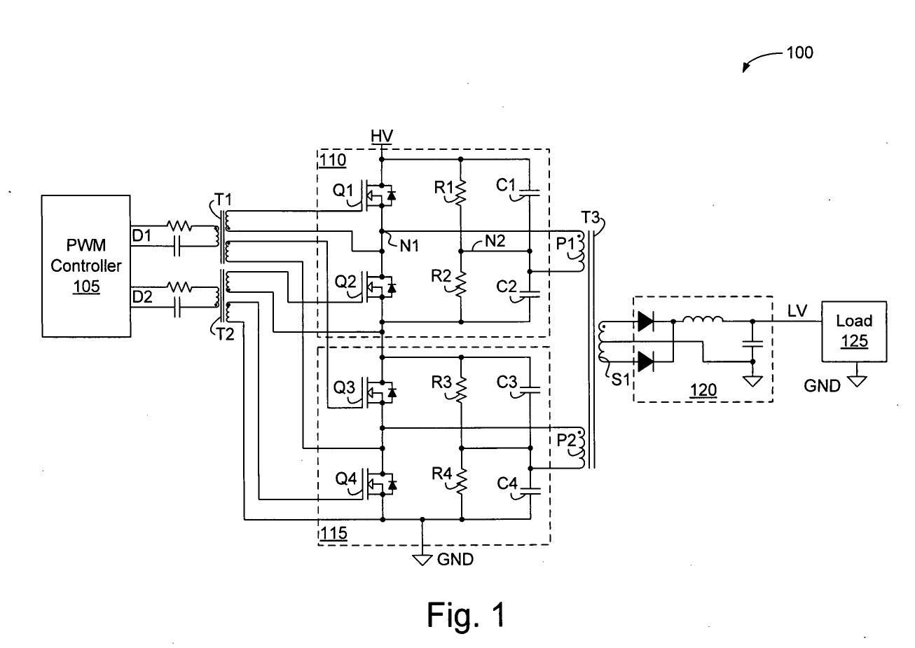

FIG. 1 depicts a voltage converter 100 in accordance with one embodiment. A relatively high supply voltage is divided across a number of components such that none of the components receives the full supply voltage. Accordingly, voltage converter 100 can be assembled using relatively small and inexpensive components.

Converter 100 includes a PWM controller 105, a first transformer T1, a second transformer T2, a pair of bridge circuits 110 and 115 disposed between supply terminals HV and ground, a third transformer T3, and a rectifier 120. PWM controller 105, via transformers T1 and T2, stimulates bridge circuits 110 and 115 to drive current in alternate directions through respective primary windings P1 and P2 of transformer T3, and thereby develop an alternating voltage across the secondary winding S1. Transformer T3 steps down the high DC supply voltage HV to create a relatively lower voltage signal across secondary S1. Converter 100 is a DC-to-DC converter in this embodiment, so rectifier 120 is included to covert the alternating signal across secondary S1 into a relatively low DC output voltage LV to a load 125.

Bridge circuit 110 includes series-connected transistor switches Q1 and Q2, a series pair of resistors R1 and R2, and a series pair of capacitors C1 and C2. The first primary winding P1 of transformer T3 is coupled between a first node N1 common to transistors Q1 and Q2 and a second node N2 common to resistors R1 and R2 and capacitors C1 and C2. Bridge circuit 115 is essentially identical, and includes series connected transistor switches Q3 and Q4, a pair of resistors R3 and R4, and a series pair of capacitors C3 and C4. The second primary winding P2 of transformer T3 is coupled between a node common to transistors Q3 and Q4 and a node common to all four of resistors R3 and R4 and capacitors C3 and C4. Resistors R1 and R2 ensure the voltage across respective capacitors C1 and C2 remains below the breakdown voltage of the capacitors. Resistors R1 and R2 likewise, via primary P1, divide the voltage across transistors Q1 and Q2, which are 800-volt MOSFETs in an embodiment in which voltage HV is about 1,400 volts. In general, the transistors should be rated to withstand more than HV/N volts, where N is the number of bridge circuits stacked between the high-voltage supply terminals. Other embodiments can employ different types of switches, such as insulated-gate bipolar transistors.

PWM controller 105 produces a pair of drive signals D1 and D2, one on the primary winding of transformer T1 and the other on the primary winding of transformer T2. Drive signals D1 and D2 may be square waves timed to a common clock pulse (not shown), and can be pulse-width modulated to change the power delivered to load 125. Controller 105 may be set to define a dead time when switching between transistors to prevent shorting the high-voltage supply terminals HV to ground. PWM controllers are commercially available and are well-known to those of skill in the art. A detailed discussion of PWM controller 105 is therefore omitted for brevity.

Converter 100 is off, which means voltage level LV is zero, when input signals IN and IN\ are held equal. Resistors R1-R4 divide the high voltage between the supply terminals equally among capacitors C1-C4 to prevent potentially damaging voltages from developing across the capacitors and transistors. Furthermore, the RMS current is provided to transformer T3 is divided between to capacitors, which further reduces the stress on capacitors C1-C4.

To turn on converter 100, PWM controller 105 introduces complementary square waves on terminals IN and IN\ such that difference signal IN-IN\ is presented across the primary winding of transformer T1. Signal IN-IN\ periodically reverses polarity, and consequently reverses the direction of current flow through the primary and secondary windings of transformer T1. Transistors Q1 and Q3 turn on and transistors Q2 and Q4 turn off when current flows through the secondary winding of transformer T1 in a first direction, and transistors Q1 and Q3 turn off and Q2 and Q4 turn on when current flows in the opposite direction. Signal IN-IN\ thus causes converter 100 to alternately turn on transistor pairs Q1/Q3 and Q2/Q4.

When PWM controller 105 turns transistors Q1 and Q3 on, current flows from capacitors C1 and C2 through primary winding P1 to the node common to capacitors C1 and C2; and from capacitors C3 and C4 through primary winding P2 to the node common to capacitors C3 and C4. Because pairs of capacitors provide current through each primary winding, each of capacitors is required to accommodate half of the total RMS current through one primary. Capacitors C1-C4 can therefore be smaller, less expensive, or both.

PWM controller 105 then turns transistors Q1 and Q3 off briefly before turning transistors Q2 and Q4 on to prevent a direct short between the supply terminals and across each bridge circuit. With transistors Q2 and Q4 on, the charge on the node common to capacitors C1 and C2 discharges through primary winding P1 and transistor Q2, and the charge on the node common to capacitors C3 and C4 discharges through primary winding P2 and transistor Q4. Turning on transistors Q1 and Q3 and turning off transistors Q2 and Q4 begins the cycle anew. PWM controller 105 thus stimulates bridge circuits 110 and 115 to pass high-voltage alternating current through primary windings P1 and P2, and consequently through secondary winding S1. Rectifier 120 rectifies the resulting signal across secondary winding S1 to provide the relatively lower DC output voltage LV.

In an embodiment in which the voltage across bridge circuits 110 and 115 is 1,200 volts, the alternating DC signal developed on the node common to transistors Q1 and Q2 alternates between approximately 600 volts and approximately 1,200 volts, and the node common to transistors Q3 and Q4 alternates between zero and 600 volts. None of the components experience the full 1,200 volts from the power supply, which allows for selection of smaller, less expensive components, a longer mean time between failures, or both.

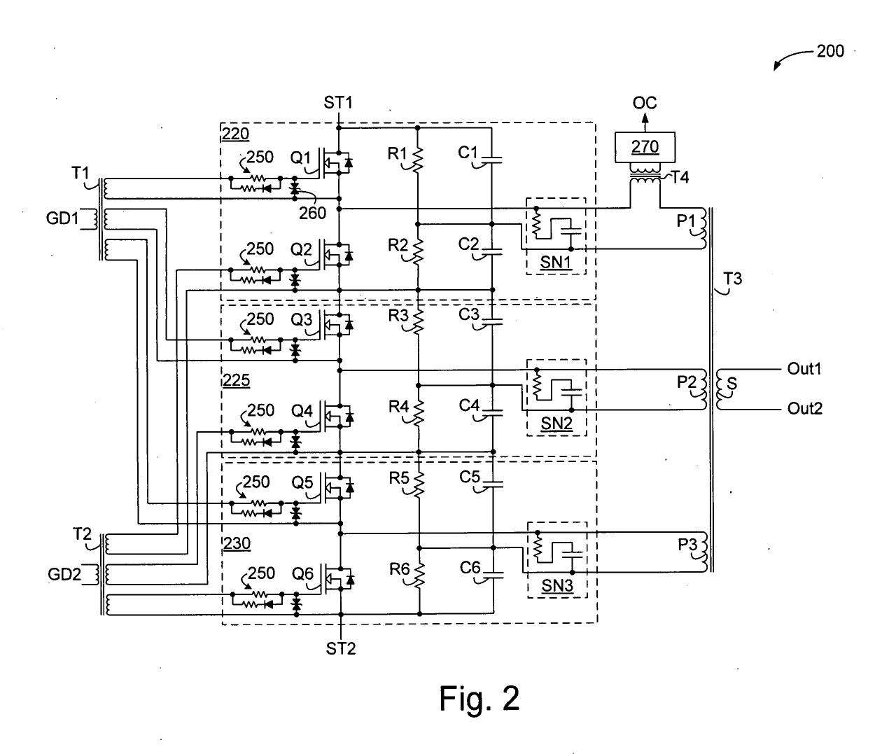

FIG. 2 depicts a voltage converter 200 in accordance with another embodiment. Converter 200 includes four transformers T1, T2, T3, and T4; three bridge circuits 220, 225, and 230; and a current monitor 270. Bridge circuits 220, 225, and 230 extend between supply terminals ST1 and ST2, which provide DC supply voltage levels that differ by about 1,800 volts in one embodiment. The bridge circuits are identical in this example, so the following discussion is limited to bridge circuit 220 for brevity.

Bridge circuit 220 is similar to bridge circuit 110 of FIG. 1, like-labeled elements being the same or similar. The gates of transistors Q1 and Q2 are coupled to respective secondary windings of transformers T1 and T2 via an optional parallel connection 250 of a resistor and a diode-resistor series combination, which may be included to increase the turn-off time relative to the turn-on time, and thereby provide some degree of protection against cross-conduction between the transistors within each bridge circuit. The sources of transistors Q1 and Q2 are coupled to their respective gates via transorbs 260, which prevent over-voltage conditions from damaging the gate/source junction. A snubber circuit SN1 extends between the input terminals of primary P1 to suppress (“snub”) electrical transients, and thereby protects the components of bridge circuit 220. The snubber circuits additionally improve the stability between bridge circuits 220, 225, and 230. Other forms of snubber circuits might also be used, or snubber circuits may be omitted in other embodiments.

Bridge circuits 220, 225, and 230 provide outputs on respective primary windings P1, P2, and P3 of transformer T3. The output voltage is taken across terminals OUT1 and OUT2 from the secondary S of transformer T3. Transformer T4 is coupled between current-sense circuit 270 and the output of bridge circuit 220. Circuit 270 issues an over-current alarm OC when the output current from bridge 220 exceeds a predefined threshold. Alarm OC can be used to shut down or otherwise limit the output power of converter 200.

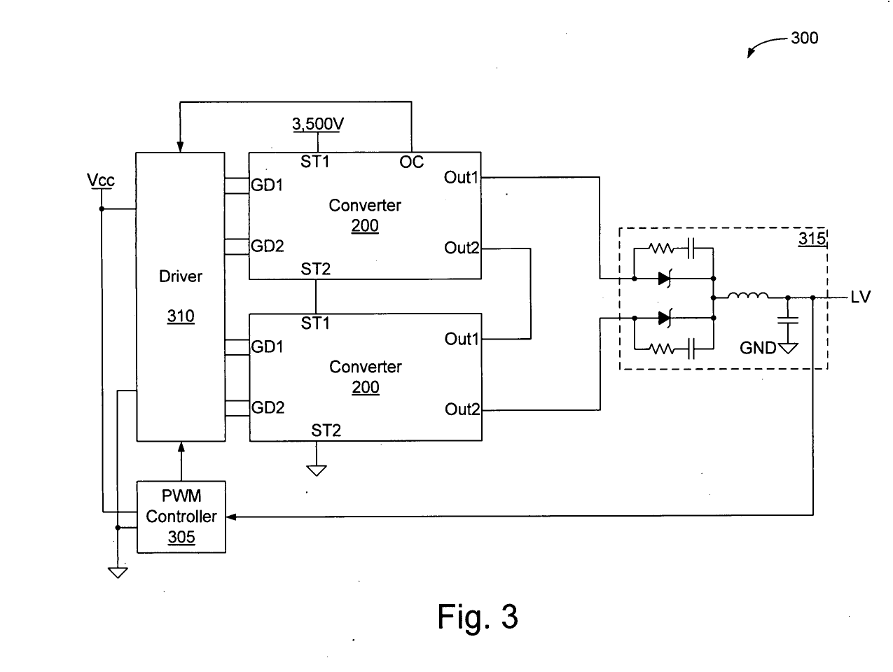

FIG. 3 depicts an output-regulated DC-to-DC converter system 300 in accordance with another embodiment. System 300 combines a pair of voltage converters 200 of the type detailed in connection with FIG. 2 to down-convert 3,600 volts DC (VDC) to about 35 VDC between a low-voltage output node LV and ground GND. A conventional PWM controller 305, via a driver 310, provides pulse-width-modulated input stimuli to ports GD1 and GD2 of both voltage converters 200, the outputs of which are serially connected across a rectifier 315. Controller 305 senses and regulates output voltage LV by controlling the duty cycles of the stimulus signals to converters 200.

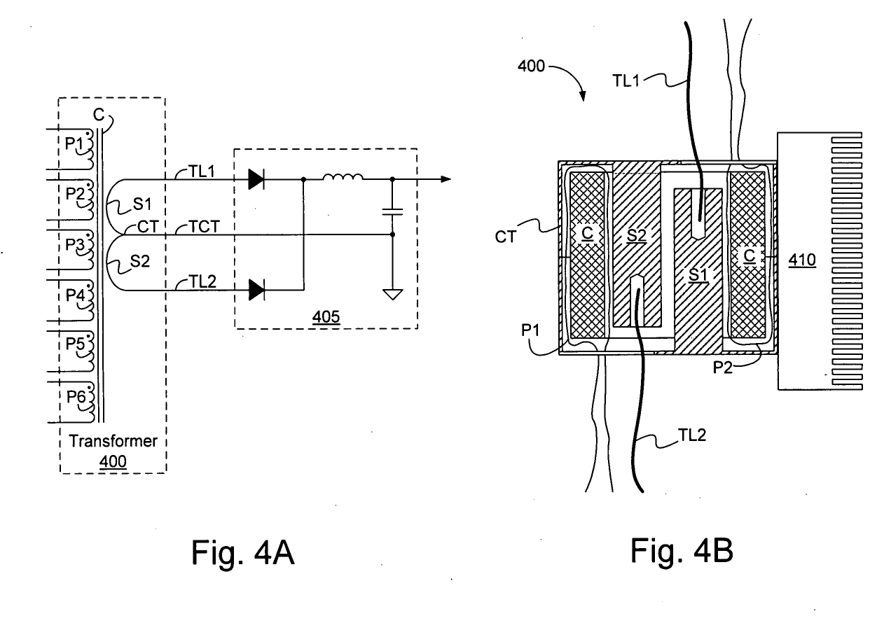

FIG. 4A schematically depicts an output transformer 400, in accordance with one embodiment, coupled to a conventional rectifier 405. Transformer 400 has six primary windings P1-P6, a core C, and two secondary windings S1 and S2 divided by a center tap CT. Transformer 400 is coupled to rectifier 405 via a pair of output lines TL1 and TL2 and a center-tap line TCT. An embodiment of transformer 400 with three primary windings can be used in place of output transformer T3 of FIG. 2, while the depicted embodiment can be used with the stacked configuration of FIG. 3 to receive six input signals, three from each of the two stacks of bridge circuits.

FIG. 4B is a cross-sectional view of transformer 400, in accordance with one embodiment, mounted to an optional heatsink 410. The labels of FIG. 4A are reproduced in FIG. 4B to identify the physical structures of transformer 400 that correspond to the like-identified circuit nodes and features of FIG. 4A. Primary windings P3-P6 are omitted in FIG. 4B for ease of illustration. The following discussion details the physical components identified in the cross section of 4B and shows how they are combined to form a robust, compact, and efficient transformer.

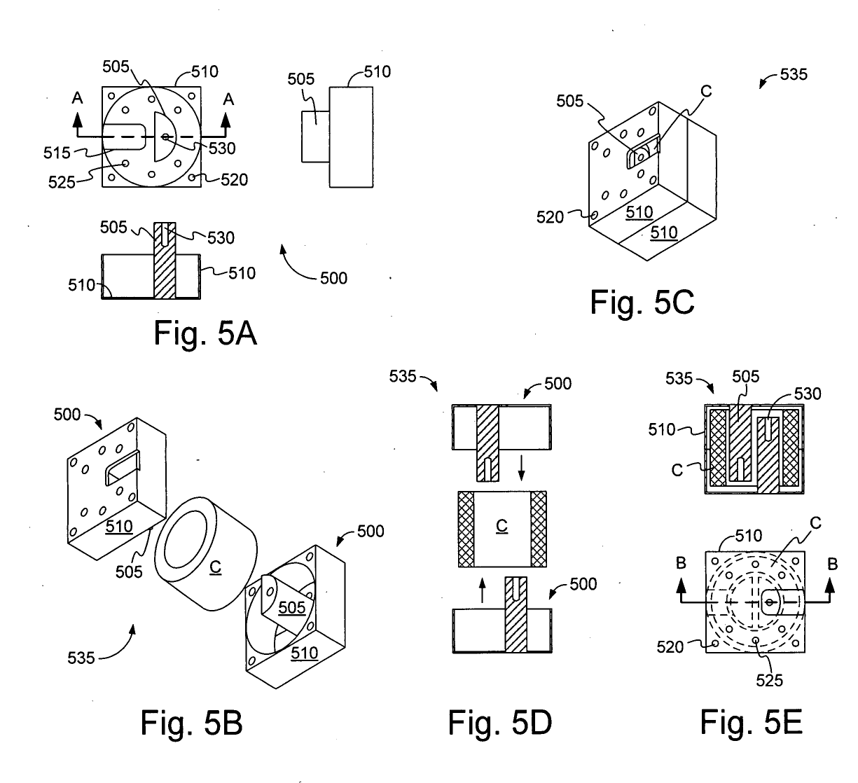

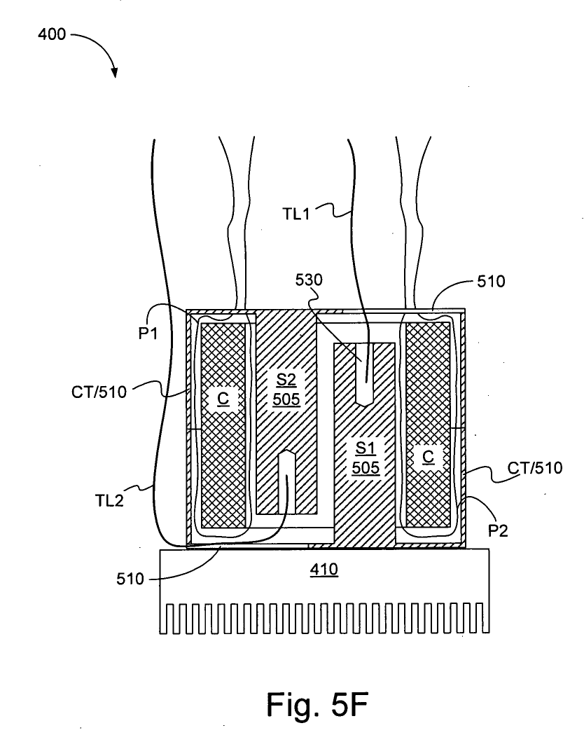

FIG. 5A includes plan, side, and cross-sectional views of a component 500 for use in transformer 400 of FIG. 4B. Component 500 includes a projection 505, a housing portion 510, an aperture 515, assembly holes 520, ports 525, and a connection hole 530. The functions of these elements will be discussed below. The lowermost view is a cross-section taken along line A-A of the plan view.

FIG. 5B is an exploded view of a transformer body 535, which includes an opposing pair of components 500 of FIG. 5A, and a cylindrical core C. The two components 500 mate together such that their respective projections 505 extend through core C and housing portions 510 encompass core C. FIG. 5C depicts the resulting assembly 535.

FIG. 5D shows an exploded view of assembly 535 similar to that of FIG. 5B but in cross-section.

FIG. 5E shows the elements of FIG. 5D assembled, in cross-section, and includes a plan view of the resulting assembly 535 to identify the cross-section of FIG. 5D as along line B-B.

FIG. 5F is essentially the same view of transformer 400 provided in FIG. 4B but amended to include labels for the physical features of the same transformer illustrated schematically in FIG. 4A. Winding s P3-P6 are omitted for ease of illustration, and heatsink 410, primary P1, and secondary line TL2 are positioned differently to provide access to all the connections from one side of the transformer. The leads to primary windings P1 and P2 enter the transformer via ports 525 (FIG. 5A); primary windings P1 and P2 wrap around core C some number of times. The number of turns each primary winding takes around core C will depend upon the desired voltage step to be provided by the transformer. Projections 505 of the two components 500 brought together to form the body of transformer 400 extend through core C to become the two secondary windings S1 and S2. The two housing portions 510 together form both the transformer housing and center tap CT. In this way, both the primary and secondary windings are adjacent and in close proximity to the core.

Housing portions 510 can be formed of conductive materials, such as aluminum or copper, and can be connected together by extending fasteners through assembly holes 520 (FIG. 5A), though different methods of fastening housing portions 510 might also be used. Whatever the mechanism, the resulting connection should be robust and provide low electrical resistance. Cavities within the assembly can be filled with a suitable potting compound.

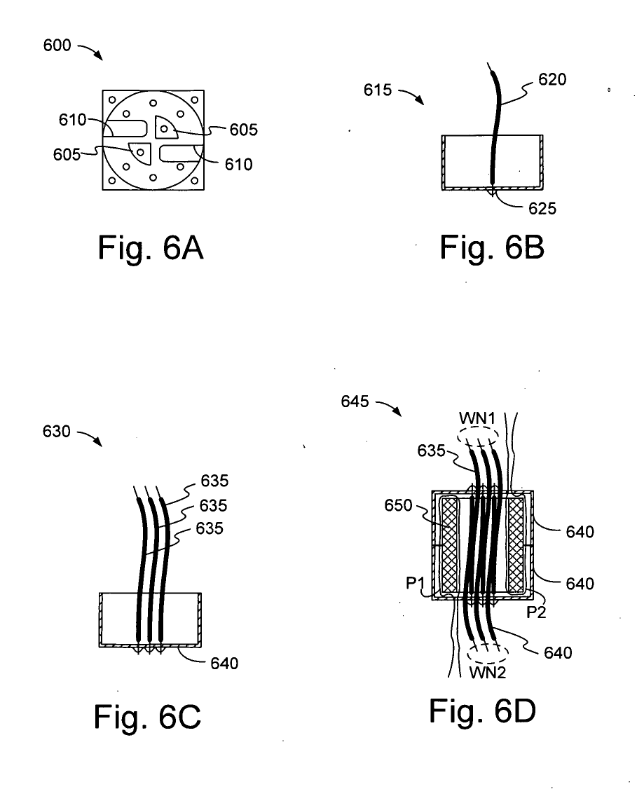

The embodiment of FIG. 5F is compact, efficient, and easily manufactured. Further, the resulting package can easily include or otherwise accommodate a heatsink. The invention can easily be extended to other shapes, materials, and configurations, as will be understood to those of skill in the art. Some examples are detailed in connection with FIGS. 6A-6D.

FIG. 6A depicts a housing portion 600, in accordance with another embodiment, that can be used with another similar juxtaposed housing portion (not shown) to form a transformer housing similar to that of FIG. 5A-5D. Housing portion 600 is similar to housing portion 510 of FIG. 5A except that portion 600 includes a bifurcated primary (two furcations 605) in lieu of a single protrusion 505, and includes two apertures 610 through which to admit conductors to connect to furcations 605 on the juxtaposed housing portion.

FIG. 6B depicts a housing portion 615 in accordance with yet another embodiment. A single secondary winding 620 is formed using a conductor connected (e.g., soldered) to housing portion 615 at a bond 625. Winding 620 functions like protrusion 505 of FIGS. 5A-5D, may include one or a plurality of striations, and may be insulated. Additional striations increase the effective surface area of winding 620, which may in turn improve performance at relatively high frequencies.

FIG. 6C depicts a housing portion 630 in accordance with an embodiment in which a single-turn winding is formed of three conductors 635 attached to a housing portion 640.

FIG. 6D depicts a transformer 645 that employs two juxtaposed housing portions 630 of FIG. 6C to form a second of windings and a center tap. Transformer 645 additionally includes a core 650 and a second pair of windings P1 and P2. As in earlier examples, windings P1 and P2 wrap around the core one time, but this is just one example. The ends of the three uppermost conductors 635 may be tied together to form a single winding node WN1, while the lowermost conductor 635 may be tied together to form a single winding node WN2. As before, conductors 635 may be single or multi-conductor, and may be insulated.

While the present invention has been described in connection with specific embodiments, variations of these embodiments will be obvious to those of ordinary skill in the art. For example, the sense of the transformers disclosed above can be reversed so that those windings described as “primary” would be “secondary” windings, and vice versa. Moreover, some components are shown directly connected to one another while others are shown connected via intermediate components. In each instance the method of interconnection, or “coupling,” establishes some desired electrical communication between two or more circuit nodes, or terminals. Such coupling may often be accomplished using a number of circuit configurations, as will be understood by those of skill in the art. Therefore, the spirit and scope of the appended claims should not be limited to the foregoing description. Only those claims specifically reciting “means for” or “step for” should be construed in the manner required under the sixth paragraph of 35 U.S.C. §112.

What is claimed is:

1. A transformer comprising:
a core;
a first winding adjacent the core;
a second winding adjacent the core; and
a center tap connected to the second winding and physically encompassing the first winding and the core.

2. The transformer of claim 1, wherein the second winding extends from the center tap through the core.

3. The transformer of claim 2, further comprising a third winding extending from the center tap through the core.

4. The transformer of claim 3, wherein the third winding extends in a first direction and the second winding extends in a second direction substantially opposite the first direction.

5. The transformer of claim 1, further comprising a conductor extending to the second winding through an aperture in the core.

6. The transformer of claim 1, wherein the center tap includes first and second housing portions.

7. The transformer of claim 6, wherein the second winding includes a first projection extending through the core from the first housing portion and a second projection extending through the core from the second housing portion.

8. The transformer of claim 1, wherein the first winding is a primary winding and the second winding is a secondary winding.

9. A transformer body comprising:
first and second housing portions that mate to form a housing for encompassing a transformer core;
a first projection extending from the first housing portion to extend through the core; and
a second projection extending from the second housing portion to extend through the core.

10. The transformer body of claim 9, further comprising the core.

11. The transformer body of claim 9, wherein the first and second projections extend in opposite directions when the first and second housing portions form the housing.

12. The transformer body of claim 9, wherein the housing encompasses the transformer core and a first winding wound about the core, the first and second projections are second windings, and the housing is a center tap.

13. The transformer body of claim 12, wherein the first winding is a primary winding and the second winding is a secondary winding.

14. A kit for creating a transformer, the kit comprising:
a transformer core; and
first and second housing portions that mate to form a housing for encompassing the transformer core, the first housing portion having a first projection extending from the first housing portion to extend through the core, and the second housing portion having a second projection extending from the second housing portion to extend through the core.

15. The kit of claim 14, wherein the first and second projections form a winding when extended through the core.

16. The kit of claim 15, wherein the winding is a secondary winding.
